(19) United States
(12) Patent Application Publication
(10) Pub. No.: US 2023/0051562 A1
(43) Pub. Date: Feb. 16, 2023

(54) STIRLING POWERED UNMANNED AERIAL VEHICLE

(71) Applicant: Quantum Industrial Development Corp., San Antonio, TX (US)

(72) Inventors: JOSEPH SHAE MCDOWELL, San Antonio, TX (US); WILLIAM C. JONES, Austin, TX (US); J.R. KINSEY, Helotes, TX (US); J. HAROLD IDELL, Sedona, AZ (US)

(21) Appl. No.: 17/793,011

(22) PCT Filed: Jan. 14, 2021
(86) PCT No.: PCT/US21/13508

§ 371 Date: Jul. 14, 2022

Related U.S. Application Data
(60) Provisional application No. 62/961,114, filed on Jan. 14, 2020.

(30) Foreign Application Priority Data
Jan. 14, 2020 (US) 62961114

(51) Int. Cl. B64C 39/02; B64D 27/10; F02G 1/04

(52) U.S. Cl. CPC B64C 39/024; B64D 27/10; F02G 1/04; B64C 2201/04; B64C 2201/02

(57) ABSTRACT

An unmanned aerial vehicle (UAV) (103) is provided which includes a radioactive fuel source (111), and an external combustion engine (107) powered by said radioactive fuel source.

### CROSS-REFERENCE TO RELATED APPLICATION

This application is a national stage filing of PCT/US21/13508, filed on Jan. 14, 2021, having the same inventors and the same title, and which is incorporated herein by referenced in its entirety; which claims the benefit of priority from U.S. provisional application No. 62/961,114, filed Jan. 14, 2020, having the same inventors and entitled “STIRLING POWERED UNMANNED AERIAL VEHICLE”, which is incorporated herein by referenced in its entirety.

### FIELD OF THE DISCLOSURE

The present disclosure pertains generally to external combustion engines, and more particularly to unmanned aerial vehicles (UAVs) equipped with Stirling Cycle engines.

### BACKGROUND OF THE DISCLOSURE

Drones and other unmanned aerial vehicles (UAV) are utilized in various applications today, including commercial, scientific, recreational, agricultural, and other applications. Small UAVs commonly utilize lithium-polymer batteries (Li—Po), while larger UAVs often rely on conventional airplane engines.

Information disclosed in this Background of the Invention section is only for enhanced and detailed understanding of the general background of the invention. It should not be taken as an acknowledgement, or any form of suggestion, that this information forms prior art to anything disclosed herein.

### SUMMARY OF THE DISCLOSURE

In one aspect, an unmanned aerial vehicle (UAV) is provided which comprises (a) a radioactive fuel source; and (b) an external combustion engine powered by said radioactive nuclear isomer fuel source.

### BRIEF DESCRIPTION OF THE DRAWINGS

FIG. 1 is an illustration of a particular, non-limiting embodiment of a UAV in accordance with the teachings herein.

### DETAILED DESCRIPTION OF THE DISCLOSURE

The time during which an unmanned aerial vehicle (UAV) can remain in flight is an important aspect of its functionality. For example, the ability of a UAV to remain in flight for extended periods of time is a significant advantage in surveillance activities, such as the kind used in military applications. Since the time in flight is directly affected by the weight of the UAV, significant effort has been undertaken to reduce the weight of these devices. However, at present, the time in flight of UAVs is still severely restricted by the weight of the fuel used to power the vehicle.

It has now been found that the foregoing issue may be addressed through the use of a UAV which is powered by a suitable radioactive material in conjunction with a suitable external combustion engine. The combination of an external combustion engine with such a fuel source may be utilized to keep the UAV in flight indefinitely.

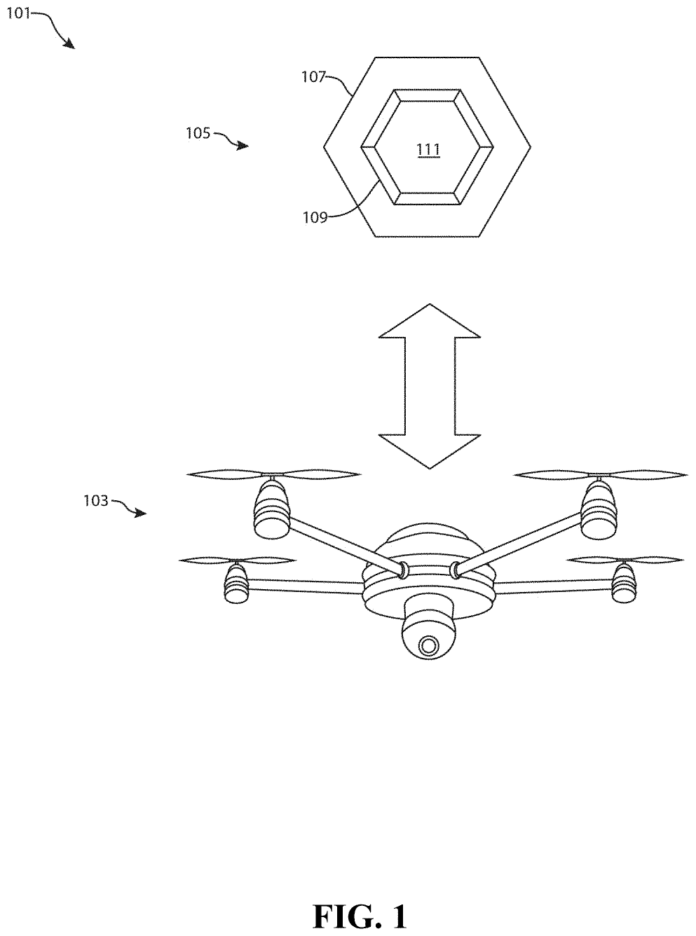

FIG. 1 depicts a particular, non-limiting embodiment of a UAV in accordance with the teachings herein. The UAV 101 depicted comprises an airborne vehicle 103 (in this case, a drone) equipped with a power core 105. The power core 105 comprises a Stirling Cycle engine 107 equipped with a radioactive power source 111. A plurality of heater tubes 109 are disposed around the radioactive power source 111.

The UAVs disclosed herein may have various form factors. For example, these UAVs may be implemented as fixed-wing aircraft, rotorcraft (including, for example, rotorcraft with a plurality of lift-generating rotors such as, for example, tricopters and quadcopters, and rotorcraft with coaxial rotors, cyclorotors, intermeshing rotors, tail rotors, tandem rotors, and transverse rotors), or in other form factors.

Various external combustion engines may be utilized in the UAV including, for example, Stirling Cycle engines (including, without limitation, those of types of Alpha, Beta or Gamma designs) or Ericsson Cycle engines. The Stirling Cycle engine and the Ericsson Cycle engine are external combustion heat engines which employ similar adiabatic closed circuit expansion and compression of a working fluid to derive kinetic energy from the internal piston-displacers. These two cycles differ in that the Stirling Cycle is isothermal, and the Ericsson Cycle is isobaric.

The use of radioactive materials which emit beta particles is preferred as the heat source for the external combustion engine in the UAVs disclosed herein. The use of ¹³⁷Cs and ¹³⁴Cs (which have respective half lives of 30 and 2.1 years) is more preferred, and the use of ¹³⁷Cs is especially preferred, although in some embodiments, the use of radioisotopes of thorium may also be preferred (in lieu of, or in combination with, one or more radioisotopes of cesium). The use of fluoride salts of these radioisotopes is also preferred, since such salts are water insoluble and hence present less of an environmental risk. These materials may be present as thermopiles, which may be encased in a suitable thermally conducting glass (such as, for example, obsidian). In some embodiments, this glass may be doped with cubic boron nitride (C—BN). In some embodiments, the thermopile array may be fashioned as a removable component to allow for safe storage of the UAV.

In some embodiments, the radioactive materials utilized in the UAVs disclosed herein may comprise nuclear isomers of radioactive elements that are irradiated with protons. This process increases the thermal properties of the resulting material without increasing the fast properties of the element. By irradiating the nuclear isomers in this fashion, the resulting material emits Beta particles while generating great quantities of thermal energy. This thermal energy can then be used in a Stirling Cycle engine or other external combustion engine to power the UAV, since external combustion engines may be utilized with a wide array of heat sources. This source of thermal energy may be exceptionally long lived, depending on the choice of radioactive element(s) employed.

Since the radioactive heat sources which may be utilized in the UAVs disclosed herein may be relatively long lived and may not be able to be readily switched off (operation may be occurring on a half-life scale of the radioactive material), it is not typically possible to start up or shut down the heat source in a conventional way. In some embodiments, a kick start procedure may be utilized as a start process (not unlike a jet engine). Preferably, however, the kick starter is fashioned as an external component to save on weight.

The shut-down procedure may be accomplished in various ways. Preferably, it is accomplished by venting the working fluid of the external combustion engine (typically hydrogen, in the case of a Sterling Cycle engine) to the atmosphere, or by short circuiting the working fluid internally within the kinematic side of the gas circuit. Either of these methods may be utilized to shut down a Stirling Cycle engine utilized in UAVs of the type disclosed herein.

In a preferred embodiment, the external combustion engine utilizes one or more heat pipes and/or Peltier junctions to minimize hot spots, to allow heat to be distributed advantageously from a heat source to another part of the engine or vehicle, or to allow heat to be dissipated to the external environment. In some embodiments, the use of such heat pipes may reduce or eliminate the overheating or degradation of seals within the engine.

UAVs may be produced in accordance with the teachings herein which have little or no thermal signature, have a low acoustic signature, and are able to stay aloft for more than 1000 hours by configuring an external combustion engine (and preferably a Sterling Cycle engine) as the power plant of an electrically driven UAV.

The general adaptation of the configuration of radioactive isomer into a Stirling Cycle engine generator (or other external combustion engine generator) having a weight-to-power ratio suitable for aviation may be achieved in various ways.

In some embodiments, a two-cylinder Stirling Cycle engine or Ericsson Cycle engine may be utilized with the heater tubes arranged in bundles around the isomer core, the latter of which preferably conforms to the geometry (or collective geometry) of the tubes. For example, the power core or fuel source may have a first shape, and the heat pipes may have a second shape, at least a portion of which is complementary to at least a portion of the first shape. The cold side of the engine may be cooled by heat pipes, which may eliminate the need for a cooling pump.

In other embodiments, a plurality of two-cylinder Stirling engines running in parallel may be provided to power generators for larger airframes.

In still other embodiments, free piston Stirling generators may be utilized to power very small airframes (e.g., those having wingspans of 10 cm or less).

The UAVs disclosed herein may utilize Li ion batteries as a buffer for the varying power demands. Preferably, however, ultra-capacitors are employed exclusively, since this will typically result in a more favorable weight-to-power ratio.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. An unmanned aerial vehicle (UAV), comprising:
a radioactive fuel source; and
an external combustion engine powered by said radioactive fuel source.

2. The UAV of claim 1, wherein said radioactive fuel source emits beta particles.

3. The UAV of claim 1, wherein said radioactive fuel source comprises cesium-137.

4. The UAV of claim 1, wherein said radioactive fuel source comprises cesium-134.

5. The UAV of claim 1, wherein said radioactive fuel source comprises a fluoride salt of cesium.

6. The UAV of claim 1, wherein said radioactive fuel source comprises a fluoride salt of thorium.

7. The UAV of claim 1, wherein said radioactive fuel source comprises a radioactive isomer.

8. The UAV of claim 1, wherein said UAV is selected from the group consisting of fixed-wing aircraft and rotorcraft.

9. The UAV of claim 1, wherein said external combustion engine is selected from the group consisting of Stirling Cycle engines and Ericsson Cycle engines.

10. The UAV of claim 1, wherein said UAV is equipped with a power core comprising said external combustion engine, said fuel source, and a plurality of heater tubes disposed about said fuel source.

11. The UAV of claim 1, wherein said external combustion engine operates in at least one cycle selected from the group consisting of isothermal cycles and isobaric cycles.

12. The UAV of claim 1, wherein said radioactive fuel source is present as a plurality of thermopiles.

13. The UAV of claim 1, wherein said plurality of thermopiles are encased in a glass.

14. The UAV of claim 13, wherein said glass is doped with boron nitride.

15. The UAV of claim 1, wherein said external combustion engine is a plurality of two-cylinder Sterling Cycle engines running in parallel.

16. The UAV of claim 1, wherein said external combustion engine is a plurality of two-cylinder Ericcson Cycle engines running in parallel.

17. The UAV of claim 1, wherein said external combustion engine is a two-cylinder external combustion engine equipped with a plurality of heater tubes disposed about said fuel source.

18. The UAV of claim 17, wherein said fuel source has a first shape, and wherein said heat pipes have a second shape, at least a portion of which is complementary to at least a portion of said first shape.
